(19) United States
(12) Patent Application Publication
(10) Pub. No.: US 2006/0186635 A1
(43) Pub. Date: Aug. 24, 2006

(54) Lightweight, Compact, Field Transport Device for Kayaks and Canoes.

(75) Inventor: Charles Michael Stewart, San Francisco, CA (US)

Correspondence Address: Charles Michael Stewart, 1588-A Stilwell Rd., San Francisco, CA, 94129, US

(73) Assignee: Charles Michael Stewart, San Francisco, CA (US)

(21) Appl. No.: 11/307,798

(22) Filed: Feb. 22, 2006

Related U.S. Application Data
(60) Provisional application No. 60/654,896, filed on Feb. 23, 2005.

(51) Int. Cl. B60P 3/10

(52) U.S. Cl. 280/414.3

(57) ABSTRACT

A lightweight, field compactable, transport device designed to easily attach to one end of the hull of a personal paddle craft such as a kayak or a canoe, which, when pushed or pulled on the opposite end will allow the paddle craft to be securely transported over various types of terrain. The transport device is comprised of two separate, but interdependent parts or system/assemblies; the first part being a lightweight harness system and the second part being an axel/wheel assembly. The lightweight harness system of this transport device is generally composed of durable fabric, synthetic webbing, and adjustable-on-the-fly, heavy-duty buckles and hooks which comprise three main elements: an opposing Twin V-shaped harness system, a longitudinal strap and structural member connection assembly that when correctly deployed will securely and directly attach an axel/wheel assembly to either the top deck or the bottom side of the desired paddle-craft. This lightweight axel/wheel assembly is further comprised of a circular axel with quick-release securing pins, a three-part axel/wheel spacer assembly, and a durable, thick foam bumper pad surrounded with a resilient non-slip surface that will accommodate a wide range of paddle craft surfaces. This device's adjustable, lightweight harness system secures the axel/wheel assembly to the paddle-craft by suspending the axel/wheel assembly midway between the two opposing forces of tension created by tightly pulling together the twin V-shaped harness system and the structural member connection assembly, via the longitudinal strap.

### FIELD OF THE INVENTION

The present invention relates to the field of wheeled transport devices for personal paddle-craft (sometimes referred to in this document as simply “craft”), primarily referring to all different styles of kayaks (including all common kayak subclasses to include: touring kayaks, recreational kayaks, Sit-on-top kayaks, white water kayaks and surf kayaks designs) and canoes. Such devices, when affixed to one end of the paddle craft, and then the craft being lifted and pulled from the opposite end can transport the paddle craft over various terrain.

### BACKGROUND OF THE INVENTION

A single individual moving by hand, a paddle craft such as a kayak or canoe over various types of terrain out in the field of use, can find it to be an awkward, difficult or even impossible task for the recreational boater or fisherman. As such, many transport devices for carrying small, paddle craft are currently available and research of the prior art showcases a multitude of various designs. Wheeled designs of the prior art that utilize an axle/wheel assembly that are of most relevance to the current invention include: U.S. Pat. No. 5,791,279 to Hart titled “Apparatus for manually transporting a canoe”, U.S. Pat. No. 6,032,964 to Capobianco titled “Kayak transport device”, U.S. Pat. No. 6,364,336 to Jenkins titled “Rowboat/canoe transport device”, U.S. Pat. No. 4,601,481 to Maurice titled “Portable boat dolly” as well as Pat. Application Publication No. US 2006/0017246 A1 to Singer titled “Foldable field transportable cart for small boats”.

Typical of all wheeled cart/dolly designs in the prior art, the aforementioned constructions are focused primarily on the unique construction of a substantial framing or supportive unit that is intended to support the weight of the craft that is placed on top of the said unit. Indeed, the prior art constructions all intend to transport a paddle craft in such a manner as to have the bottom side of a craft rest on the top side of a structurally supportive cart/dolly unit, that contains an axle/wheel assembly and securing straps of some fashion. These prior art designs in part rely on the weight of the craft itself to help marry the cart/dolly unit to the underside of the craft and to keep the cart/dolly unit in place under the craft during transport. Additionally, a strap or set of straps which are attached to the cart are then typically secured around the hull of the craft in order to keep the craft from shifting and falling off the cart during transport of the craft over various terrain.

Unfortunately, testing of current wheeled transport devices on various commercially available paddle craft has determined that the prior art constructions typically only work well some of the time, with some small number of specific craft designs, over some limited types of terrain. The aforementioned prior art designs often perform poorly in their intended purpose due to, practically speaking: poor fitting securing straps or hooks which allow for shifting of the paddle craft while on the cart/dolly in addition to heaving heavy and cumbersome metal or composite frame/support components that can not be easily disassembled for compact stowage or that require tools to assemble, disassemble or repair while out in the field. And contrary to their stated claims, observations of prior art constructions and real-world, field testing of commercially available cart designs have uniformly shown severe limitations on the size, shape and length of the craft to which these prior art designs can reasonably work well with.

Altogether, they are uniformly deficient in respect to their inability to provide a quick, easy and practical method of securely attaching a lightweight axle/wheel assembly to the maximum range of available personal paddle craft. The dimensional adaptability of a transport device's design is particularly important for the marketplace, as many recreational boaters/fishermen own or use multiple paddle craft, each with a unique size, shape and length dimensions based on its particular style and brand manufacturer. For this situation, it is particularly advantageous for the end user to not need multiple transport devices in order to accommodate each specific style of personal paddle craft, but rather, to need only one lightweight, wheeled transport device that could be adjusted in a real-time manner to accommodate the transport of a wide range of styles of personal paddle craft.

Additionally, as many recreational boaters/fishermen who currently use transport devices are well aware of, there are other combinations of common problems in the field that currently need solving and are not being served properly by the prior art. To illustrate these shortcomings, let us examine some of the common problems as they are found in the field. For instance, a transport device attached to a loaded-down craft will encounter a wide range of unexpected types of disruptive terrain as it is transported; quite often a good distance from a vehicle parking area or down a rugged trail to the remote launch site. Other transport situations may include traveling overland to a new campsite area that may require the entire craft to be lifted up off of the ground and portaged over some otherwise un-passable obstacle. Rough and uneven terrain affects the ability of a paddle craft transport device to maintain a secure and an undamaged paddle craft by subjecting the paddle craft to high multi-directional and rotational forces as the transport device encounters such rough terrain. As such, the shifting and rotation of the paddle craft within the transport device can subject a paddle craft to damage not only from ambient objects, but also from the frame or support unit of the cart/dolly itself. In these situations, it is imperative that the transport device used stay firmly connected to the craft at all times regardless of the situations encountered in order to prevent damage to either the craft or the user caused by the craft shifting within or separating from the transport device. In addition, it is essential that when not in use in the field, that the transport device can be quickly assembled or disassembled without any tools and stowed compactly in an available standard-sized storage compartment of a kayak or stowage area of a canoe. Furthermore, it is very desirable for the parts of the stowed transport device to provide their own floatation in the event of the craft becoming capsized in water while out in the field to avoid the potential loss of the transport device.

As a consequence of the prior art's uniform shortcomings in the aforementioned situations, there has been a longstanding need for a new and improved style of transport device that can realistically and practically be securely attached to the maximum range of available personal paddle craft and also be able to address the afore mentioned situations that are commonly experienced in the field. As such, the prior art constructions do not teach the current invention. The present invention's unique combination of its light-weight, compact design, its real-time adjustability to accommodate the various sized dimensions of the widest range of available personal water craft and its secure, lightweight harness system used to attach the axle/wheel assembly to the hull of a paddle craft, uniquely allow this new transport device design to solve the problems currently found in the field and which are not presently addressed by the prior art constructions.

### OBJECT OF THE INVENTION

It is therefore a primary object of the present invention to provide a lightweight, personal paddle craft transport device that easily attaches to, and then easily transports, the maximum range of various shaped and dimensioned kayaks (including all common kayak subclasses to include touring kayaks, recreational kayaks, Sit-on-top kayaks, white water kayaks and surf kayak designs and canoes over various terrain.

It is also an object of the invention to provide a personal paddle craft transport device that mitigates the physically demanding task of transporting a paddle craft over distances and various terrain.

Another object of the present invention is to provide a personal paddle craft transport device design that will overcome the shortcomings of the prior art devices.

Yet another object to provide a personal paddle craft transport device that will stay firmly connected to the craft at all times regardless of the situations or terrain encountered in order to prevent damage to either the craft or the user caused by craft shifting or separation from the transport device.

A further object is to provide a personal paddle craft transport device with such simple design components that is easily assembled or disassembled without the use of any tools.

A still further object is to provide a personal paddle craft transport device of such small components that when disassembled, it is easily compacted to be stowed in an available standard-sized storage compartment of a kayak or stowage area of a canoe.

It is yet an additional object to provide a personal paddle craft transport device of such a lightweight design and component materials (such as air filled tires and a high flotation foam boat pad) that it will provide for self floatation, in the event that the craft in which it has been stowed becomes capsized in water and its stowed cargo becomes loose from said craft, thus keeping the device from being lost to service.

It is yet another object to provide a personal paddle craft transport device that can, depending on user's preference, be attached to the top or bottom side of the paddle craft allowing the paddle craft to be carried upright or upside down.

It is still an additional object to provide a personal paddle craft transport device that can, depending on the specific dimensions of the paddle craft, allow the craft to be connected to a bicycle for transport over various terrain.

Other objects and advantages of the present invention will become obvious to the reader and it is intended that these objects and advantages are within the scope of the present invention.

While particular preferred embodiments of the invention have been shown, it will be understood, of course, that the invention is not limited thereto since modifications may be made by those skilled in the art, particularly in light of the foregoing teachings. Reasonable variation and modifications are possible within the scope of the foregoing disclosure of the invention without departing from the spirit of the invention.

### BRIEF SUMMARY OF THE INVENTION

Briefly stated, and in keeping with these objects and others that may be apparent, the current invention relates to a wheeled, lightweight, personal paddle craft transport device that because of its flexibility in design and construction easily attaches to, and then easily transports, the maximum range of various shaped and dimensioned paddle craft over various types terrain. As will be explained in greater detail further on in the specification and drawings, the current invention is comprised of a durable yet lightweight harness system that once attached to the hull of a paddle craft and then tensioned together, will connect to either the top or bottom side of the hull of the paddle craft a lightweight axle/wheel/bumper pad assembly. Perhaps most importantly to this design, this lightweight axle/wheel/bumper pad assembly is literally ‘suspended’ between the two opposing tensioning forces caused by the tensioning together of separate components of the harness system, which are positioned longitudinally at opposite ends of the paddle craft. This method allows for a more universally accommodatingly shaped axle/wheel/bumper pad assembly to be attached longitudinally, either more fore or aft on one end of the craft's hull, to the best available attachment position, depending on the specific hull design of the craft as determined by the craft's user.

For illustrative purposes only, in the preferred embodiment of the design the lightweight harness system of the current invention is generally composed of durable fabric material, synthetic webbing, and adjustable-on-the-fly, heavy-duty buckles and hooks and is comprised of three main components: an opposing Twin V-shaped harness system, a longitudinal strap and the structural connection assembly that when correctly deployed will securely and directly attach the axle/wheel assembly to either the top deck or the bottom side of the desired paddle-craft. This lightweight axle/wheel assembly is further comprised of a circular axel rod with quick-release securing pins attached at either end of the axel for securing a pair of accompanying wheels, preferably pneumatic with bearings, to said axel, a 3 piece axle/wheel spacer assembly, and a durable, thick foam bumper pad surrounded with a resilient non-slip surface that will accommodate and provide protection against damage of the hull of the paddle craft. This device's adjustable Twin V-shaped harness secures the axle/wheel assembly to the paddle-craft by suspending the axle/wheel assembly midway between the two opposing forces of tension created by tightly tensioning apart the two opposing straps of the Twin V-shaped harness which is also directly connected to the axel of the axle/wheel/assembly. Significantly, the opposing straps of the Twin V-shaped harness are tensioned apart by needing to tension only the one longitudinal strap, which is furthermore directly connected to the structural connection assembly positioned and attached at the longitudinally opposite end of the craft, from the Twin V-shaped harness.

In addition, the current invention utilizes simple design components that are easily assembled or disassembled without the use of any tools and is easily compacted to be stowed in an available standard-sized storage compartment of a kayak or stowage area of a canoe. It's lightweight design and component materials (such as air filled tires and a high flotation foam bumper pad) will provide for self floatation, in the event that the craft in which it has been stowed becomes capsized thus keeping the device from being lost to service.

Furthermore, the current invention can, depending on user's preference, be attached to the top or bottom side of the paddle craft allowing the paddle craft to be carried upright or upside down which, depending on the specific dimensions and style of the paddle craft, allow the craft to be carried by hand or connected to a bicycle for transport over various terrain.

### BRIEF DESCRIPTION OF THE SEVERAL VIEWS OF THE DRAWING

The current invention will be best understood in connection with the accompanying drawings. It is noted that the invention is not limited to the precise embodiments shown in drawings, in which:

FIG. 1 is a Rear, end view showing the lightweight transport device attached to the rear, bottom side portion of the hull of a kayak;

FIG. 2 is a Top view of the lightweight transport device attached to the rear, bottom side portion of the hull of a kayak;

FIG. 3A is a Top view of the hook-unit used as the option #1 embodiment of the structural connection assembly.

FIG. 3B is a Top view of the fabric cone-unit used as option # 2 embodiment of the structural connection assembly.

FIG. 4 is a Side view of the lightweight transport device being attached to a kayak positioned either top-side-up or bottom-side-up. Also shows transport device connected to the back support member of a bicycle, so as to be able to be transported by bicycle and showing the relative positioning of the axle/wheel assembly away from the extreme end of the paddle craft.

FIG. 5 Top down view showing disassembly of transport device's parts, requiring no tools so as to be compacted to fit in the stowage area of a paddle craft.

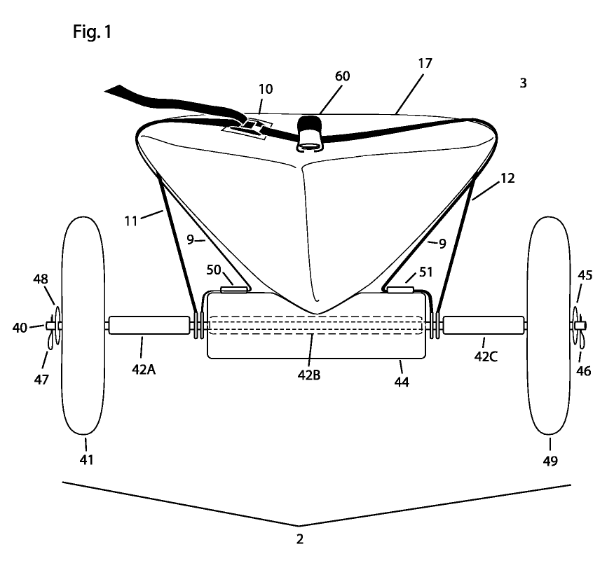

### DETAILED DESCRIPTION OF THE INVENTION

The current invention is unique from the prior art in that it is not primarily focused on the construction of a heavy, cumbersome frame or support unit for a cart/dolly; rather, the current invention seeks to use lightweight components that form a flexible harness system that attaches to structural elements of the paddle craft and that then use the structural strength of the craft itself for the desired support and attachment of the lightweight axle/wheel assembly to the surface of the paddle craft. In the current invention, this flexible, lightweight harness and axle/wheel assembly serve the same purpose for transporting the paddle craft as do the otherwise heavy, cumbersome frame or support units that are preferred by the prior art constructions.

To further illustrate this point, allow this analogous example from architecture design of building a bridge to be described: in this analogy, the prior art would be described as being of a traditional bridge construction, using substantial, heavy supports to hold the weight of a roadway placed on top of the supports. Conversely, in this same analogy, the design of the current invention would be described as a suspension bridge, wherein the roadway is suspended via a lightweight harness system between the two opposing forces of the bridge's support towers. Bridges can be constructed using either design, but the two bridges and their design methodology are radically different from each other, as is the prior art and the current invention in this analogy.

Moving onto greater detail and for illustrative purposes only, a preferred mode for carrying out the invention is described wherein, a lightweight, transport device 1 carries a personal paddle craft, such as kayak 17 over various terrain.

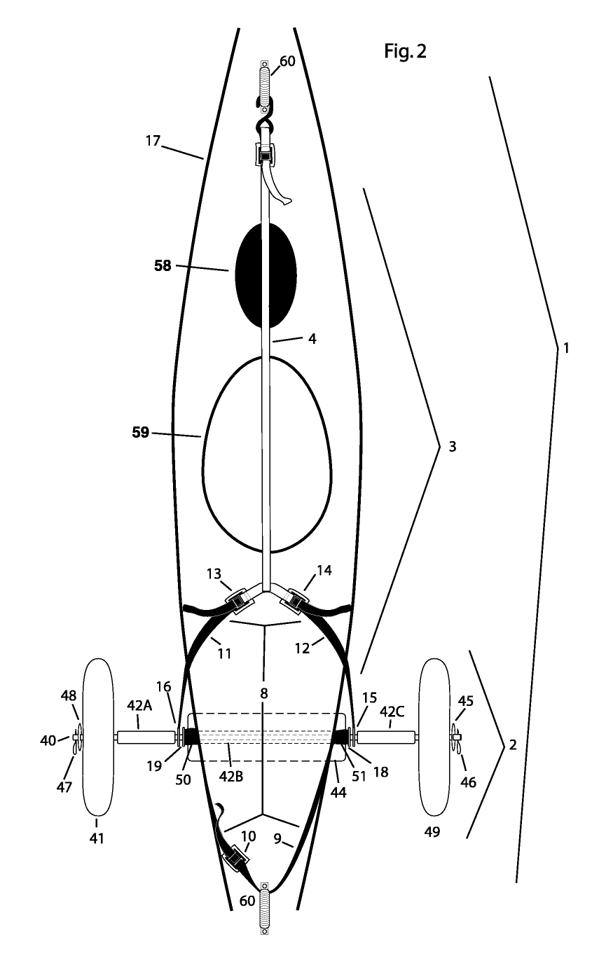

As seen in FIG. 2, the preferred embodiment of the transport device 1 is best described as being comprised of two separate, but interdependent parts or system/assemblies; the first part being a lightweight harness system 3 and the second part being an axle/wheel assembly 2.

The lightweight harness system 3 is further composed of three separate components including as the first component: a twin V-shaped harness system 8 consisting of a two-part, synthetic webbing, traverse strap 9, each end of the traverse strap 9 having a circular grommet 18, 19 and also having a spring-loaded friction buckle 10 that attaches to the rear of the kayak 17 by attaching either to a structural carry handle 60 (shown) or as just being wrapped around the rear hull of the paddle craft to cause the traverse strap 9 to form, in the first instance of this twin V-shaped harness system 8, a V-shape. The twin V-shaped harness system 8 also consists of two separate, synthetic webbing, traverse straps 11, 12, each traverse strap 11, 12 having a circular grommet 15, 16 in one end of the strap. As will be better understood after reading the entire description, these grommets 15, 16, and 18, 19 allow for the traverse straps 9, 11, 12 to be attached to the axel rod 40, via the axel rod 40 passing through the hollow part of the grommet. When the lightweight harness system 3 is connected together, the non-grommet end of traverse straps 11, 12 will attach to the spring-loaded friction buckles 13, 14 of the longitudinal strap 4 component in such a manner as to form the second instance of a V-shape, that identifies the completed twin V-shaped harness system 8.

As noted earlier, the second component of the lightweight harness system 3 is a longitudinal strap 4 having a pair of a spring-loaded friction buckles 13, 14 held in a perpendicular fashion and attached to the bottom end of the longitudinal strap 4.

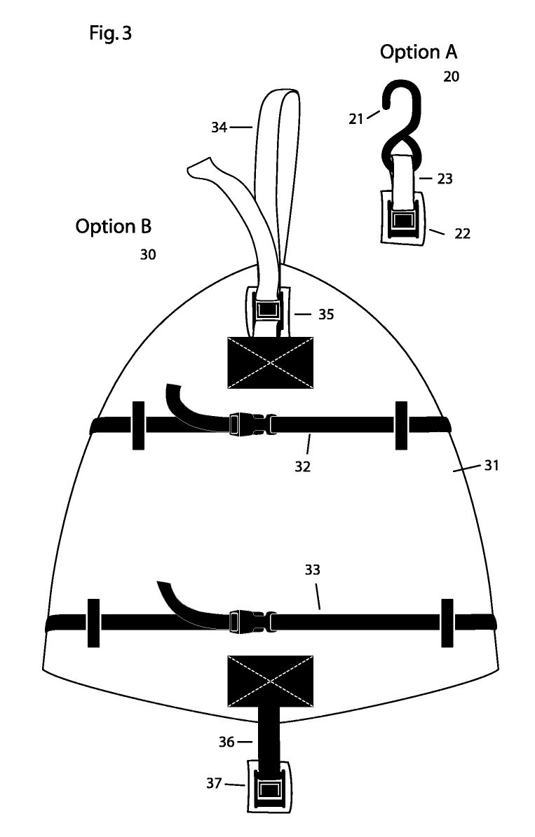

The third component of the lightweight harness system 3 is a structural connection assembly having two separate embodiments is shown in FIG. 3; the first embodiment being a hook-unit 20 having a sturdy plastic or rubber coated hook 21 connected to a spring-loaded friction buckle 22 via a section of synthetic webbing 23; to be used on paddle craft that have a structural carry handle 60 and the second embodiment being a fabric cone-unit 30 having a durable fabric piece 31, a pair of a synthetic webbing, compression straps 32, 33 for conforming the fabric cone-unit 30 to the shape of the kayak 17, a synthetic webbing, carry loop strap 34 with a spring-loaded friction buckle 35 and finally a synthetic webbing, longitudinal strap connecter point 36 with a spring-loaded friction buckle 37; to be used when the paddle craft contains no structural carry handle 60.

As mentioned earlier, the second part of the transport device 1 is an axle/wheel assembly 2. The axle/wheel assembly 2 is also further composed of several separate components including as the first component: a circular, axel rod 40 preferably, of metal or composite material and having a small hole drilled through the axel rod 40 in a perpendicular position to the axel rod 40, and located at each end of the axel rod 40 through which two quick-release lynch pins 46, 47 are attached at either end of the axel rod 40. These two quick-release lynch pins 46, 47 are used to secure to the axel rod 40, a pair of washers 45, 48 as well as the second component of the axle/wheel assembly 2; that being a set of wheels 41, 49 preferably pneumatic, and of many potential sizes and shapes that could be easily and quickly changed according to the desire of the user.

The set of wheels 41, 49, are kept separated from each other along the axel rod 40 by the third component of the axle/wheel assembly 2; that being a three-part, axel spacer 42A, 42B, 42C; each part being made of a durable, hollow, plastic tube. The axel spacer 42A, 42B, 42C is attached to the axel rod 40, via the axel rod 40 running through the hollow center of the axel spacer 42A, 42B, 42C.

The fourth component of the axle/wheel assembly 2 is the bumper pad 44; comprised of a durable, high flotation foam/rubber pad with a hollow, tube-shaped void running longitudinally through the center of the pad, which allows the bumper pad 44 to be attached to the axel 40, via the axel 40 running through the center of the void. Additionally, the bumper pad 44 is encased laterally, by a durable, fabric sleeve 43 that is covered on the top side of the sleeve with a non-slip coating. Additionally, this sleeve has two synthetic webbing loops 50, 51 attached and positioned laterally, and at either end of the sleeve; through which the separate parts of transverse strap 9, pass under the loops 50, 51 before being connected around the hull of the kayak 17.

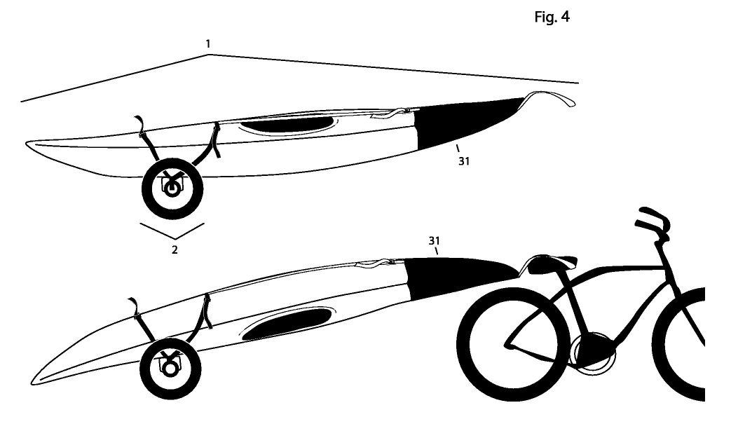

As seen in FIG. 4, once the transportation device is attached to the paddle craft the axle/wheel assembly can be generally positioned on one end of the hull of the paddle craft, but typically, not at the extreme end so as to avoid positioning the transportation device under the most extreme angle of the V-shaped hull. This position location provides for a more stable connection surface between the transportation device and the paddle craft and also has the general advantage of leveraging more of the paddle craft's weight to the axle/wheel assembly, thus making the load weight of the paddle craft easier for the user to transport.

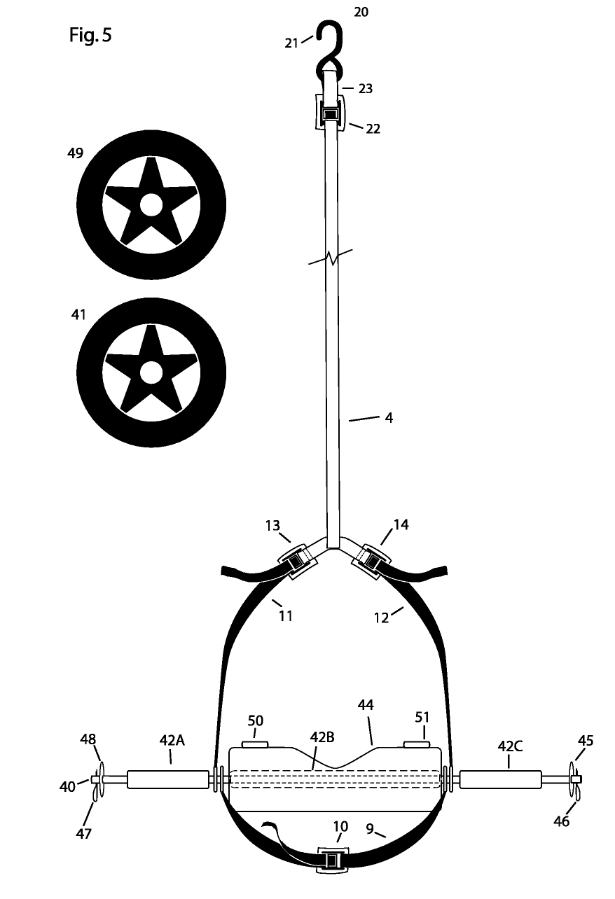

As seen in FIG. 5, this view of the disassembled components of the transport device shows that the components require no tools to assemble or disassemble and will provide for their own flotation in the event of the craft becoming capsized, via the air filled wheels 41, 49 and high flotation bumper pad 44, if kept in this configuration during stowage in the field. FIG. 5 also shows the components to be extremely compact, so as to easily fit in a stowage area, such as the cockpit 59 or stowage compartment 58 of a paddle craft as seen in FIG. 2. The parts of the stowed transport device provide their own floatation in the event of the craft becoming capsized to avoid the potential loss of the transport device.

Having thereby described the preferred embodiments of the current invention, it will be understood, of course, that the invention is not limited thereto since modifications may be made by those skilled in the art, particularly in light of the foregoing teachings. Reasonable variation and modifications are possible within the scope of the foregoing disclosure of the invention without departing from the spirit of the invention.

What is claimed is:

1. A lightweight transport device for transporting on wheels one end of a personal paddle craft such as a kayak or canoe, wherein the transport device comprises two separate, but interdependent parts or assemblies/systems to include:
a lightweight axle/wheel assembly composed of several components including: an axel rod, preferably of metal or composite material having a small hole drilled through each end of the axel rod through which two quick-release lynch pins are attached, a set of wheels preferably pneumatic, and of many potential sizes or shapes, a three-part, axel spacer being made of a durable, hollow, plastic tube, and a bumper pad made of a durable, high flotation foam/rubber pad with a hollow, tube-shaped void running longitudinally through the center of the pad; wherein the deployed lightweight axle/wheel assembly can support the load weight of a paddle craft in transit
and, a lightweight harness system comprised of three separate components, including a preferably shaped, twin V-shaped harness system , a longitudinal strap and a structural connection assembly which has two potential embodiments that can be used depending on the craft dimensions: the first embodiment form being a hook-unit, and the second embodiment form being a fabric cone-unit; wherein the deployed lightweight harness system is attached to structural components at opposite ends of the hull of the craft, providing for attachment of a lightweight axle/wheel assembly to the hull of the paddle craft, for the purposes of supporting the load weight of the paddle craft while in transit.
